(19) United States
(12) Patent Application Publication
(10) Pub. No.: US 2018/0090813 A1
(43) Pub. Date: Mar. 29, 2018

(54) Low-Cost and Low-Loss Phased Array Antenna Panel

(71) Applicant: Movandi Corporation, Newport Beach, CA (US)

(72) Inventors: Seunghwan Yoon, Irvine, CA (US); Alfred Grau Besoli, Irvine, CA (US); Maryam Rofougaran, Rancho Palos Verdes, CA (US); Farid Shirinfar, Granada Hills, CA (US); Sam Gharavi, Irvine, CA (US); Michael Boers, South Turramurra (AU); Ahmadreza Rofougaran, Newport Coast, CA (US)

(73) Assignee: MOVANDI CORPORATION

(21) Appl. No.: 15/278,970

(22) Filed: Sep. 28, 2016

(51) Int. Cl. H01Q 1/22; H01Q 21/00

(52) U.S. Cl. CPC H01Q 1/2283; H01Q 21/0025

(57) ABSTRACT

A phased array antenna panel includes a first substrate over a metallic base, a plurality of cavities in the first substrate and the metallic base, a plurality of semiconductor dies situated over the first substrate, where at least one of the plurality of semiconductor dies is situated in a semiconductor package formed in a second substrate. The semiconductor die is coupled to at least one pair of antenna probes over one of the plurality of cavities. The semiconductor die is further coupled to electrical connectors configured to carry combined horizontally-polarized signals and combined vertically-polarized signals. Each semiconductor package partially covers four of the plurality of cavities. The first substrate may include FR-4 material. The second substrate may include Rogers® material.

### RELATED APPLICATION(S)

The present application is related to U.S. patent application Ser. No. 15/225,071, filed on Aug. 1, 2016, Attorney Docket Number 0640101, and titled “Wireless Receiver with Axial Ratio and Cross-Polarization Calibration,” and U.S. patent application Ser. No. 15/225,523, filed on Aug. 1, 2016, Attorney Docket Number 0640102, and titled “Wireless Receiver with Tracking Using Location, Heading, and Motion Sensors and Adaptive Power Detection,” and U.S. patent application Ser. No. 15/226,785, filed on Aug. 2, 2016, Attorney Docket Number 0640103, and titled “Large Scale Integration and Control of Antennas with Master Chip and Front End Chips on a Single Antenna Panel,” and U.S. patent application Ser. No. 15/255,656, filed on Sep. 2, 2016, Attorney Docket No. 0640105, and titled “Novel Antenna Arrangements and Routing Configurations in Large Scale Integration of Antennas with Front End Chips in a Wireless Receiver,” and U.S. patent application Ser. No. 15/256,038 filed on Sep. 2, 2016, Attorney Docket No. 0640106, and titled “Transceiver Using Novel Phased Array Antenna Panel for Concurrently Transmitting and Receiving Wireless Signals,” and U.S. patent application Ser. No. 15/256,222 filed on Sep. 2, 2016, Attorney Docket No. 0640107, and titled “Wireless Transceiver Having Receive Antennas and Transmit Antennas with Orthogonal Polarizations in a Phased Array Antenna Panel.” The disclosures of these related applications are hereby incorporated fully by reference into the present application.

### BACKGROUND

The next generation wireless communication network may adopt very high frequency signals in the millimeter-wave range to deliver faster Internet speed and handle surging mobile network traffic. Thus, millimeter-wave antennas may be a crucial part of the next generation wireless communications system. Due to the high-loss nature of RF signals, minimizing energy loss is an important consideration in millimeter-wave antenna design, since most of the energy loss occurs between an antenna and an integrated circuit or chip processing the RF signals to be transmitted or received. In addition, fabrication cost is another important consideration as millimeter-wave antenna panels require a complex routing network to coordinate the transmission and reception operations.

Accordingly, there is a need in the art for a low-cost, low-loss, and high-performance phased array antenna panel.

### SUMMARY

The present disclosure is directed to a low-cost and low-loss phased array antenna panel, substantially as shown in and/or described in connection with at least one of the figures, and as set forth in the claims.

### BRIEF DESCRIPTION OF THE DRAWINGS

FIG. 1 A illustrates a perspective view of a portion of a phased array antenna panel according to one implementation of the present application.

FIG. 1B illustrates a perspective view of a portion of a phased array antenna panel according to one implementation of the present application.

FIG. 2A illustrates a top plan view of a portion of a phased array antenna panel according to one implementation of the present application.

FIG. 2B illustrates a top plan view of a portion of a phased array antenna panel according to one implementation of the present application.

FIG. 3A illustrates a perspective view of a portion of a phased array antenna panel according to one implementation of the present application.

FIG. 3B illustrates a perspective view of a portion of a phased array antenna panel according to one implementation of the present application.

FIG. 4A illustrates a perspective view of a semiconductor package of a phased array antenna panel according to one implementation of the present application.

FIG. 4B illustrates a functional block diagram of a radio frequency front end circuit of a semiconductor package according to one implementation of the present application.

FIG. 5 illustrates a top plan view of a semiconductor package of a phased array antenna panel according to one implementation of the present application.

FIG. 6A illustrates a cross-sectional view of a semiconductor package of a phased array antenna panel according to one implementation of the present application.

FIG. 6B illustrates a cross-sectional view of a portion of a phased array antenna panel according to one implementation of the present application.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

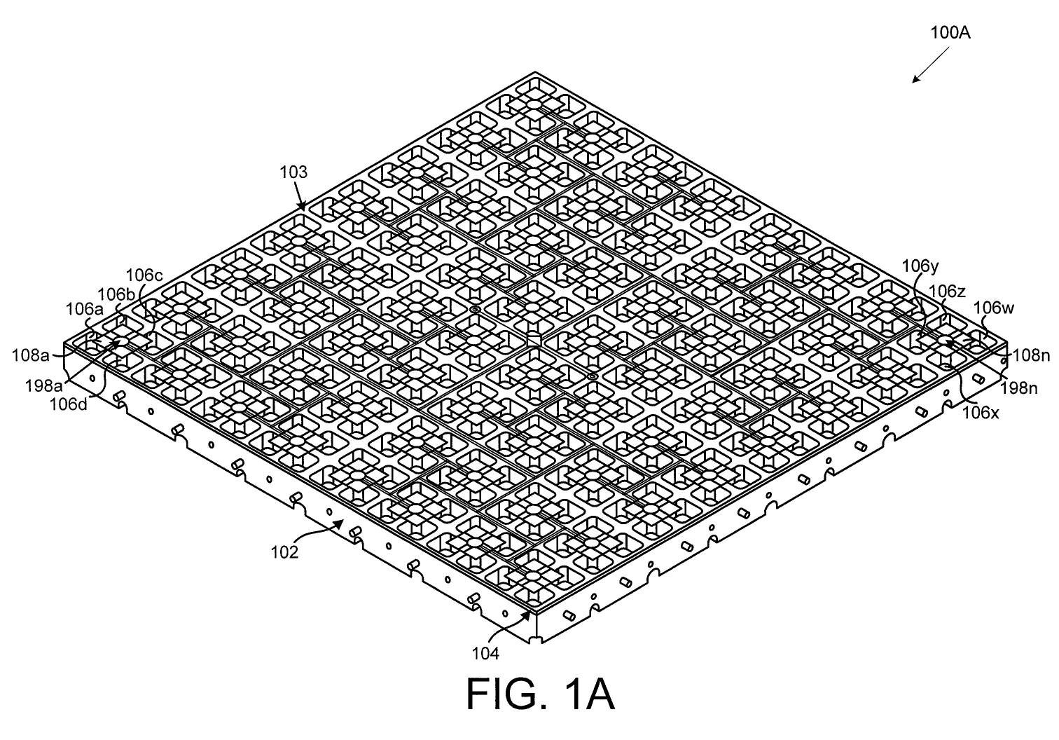

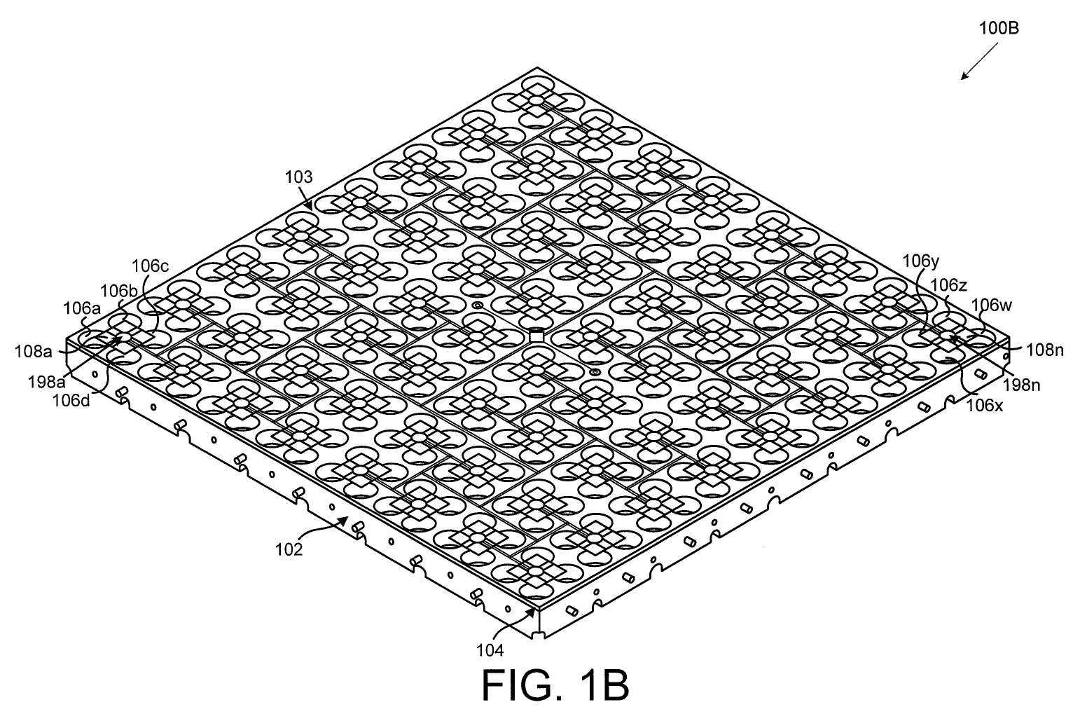

FIG. 1A illustrates a perspective view of a portion of a phased array antenna panel according to one implementation of the present application. As shown in FIG. 1A, phased array antenna panel 100A includes metallic base 102, substrate 104, a plurality of cavities such as cavities 106a, 106b, 106c, 106d, 106w, 106x, 106y and 106z (hereinafter collectively referred to as cavities 106), a plurality of semiconductor packages such as semiconductor packages 108a and 108n (hereinafter collectively referred to as semiconductor packages 108), and a plurality of moldings such as moldings 198a and 198n (hereinafter collectively referred to as moldings 198).

As illustrated in FIG. 1A, substrate 104 is situated over metallic base 102. Semiconductor packages 108 are situated over substrate 104. Cavities 106 extend through substrate 104 into metallic base 102. The formation of cavities 106 through substrate 104 into metallic base 102 creates ridges on top side 103 of phased array antenna panel 100A, where the ridges form a grid pattern. Semiconductor packages 108 are situated on and supported by the intersections of the ridges, while portions of each of semiconductor packages 108 partially extend over a group of neighboring cavities. For example, semiconductor package 108a partially extends over each of cavities 106a, 106b, 106c and 106d, while semiconductor package 108n partially extends over each of cavities 106w, 106x, 106y and 106z.

In the present implementation, metallic base 102 includes aluminum or aluminum alloy. In another implementation, metallic base 102 may include copper or other suitable metallic material. In the present implementation, substrate 104 is a low-cost substrate, such as a printed circuit/wiring board with conductive traces formed therein. In one implementation, substrate 104 may include FR-4 material, which is low cost and can deliver robust performance and durability. In one implementation, substrate 104 may include conductive traces that carry signals from each of semiconductor packages 108 to a master chip (not explicitly shown in FIG. 1A), for example. In the present implementation, each of cavities 106 has a rectangular cuboid shape with a substantially square opening on top side 103 of phased array antenna panel 100A. In the present implementation, cavities 106 are air cavities, as air has a low dielectric constant and is an excellent dielectric material for radio frequency antenna applications. In another implementation, cavities 106 may be filled with other suitable dielectric material with a low dielectric constant.

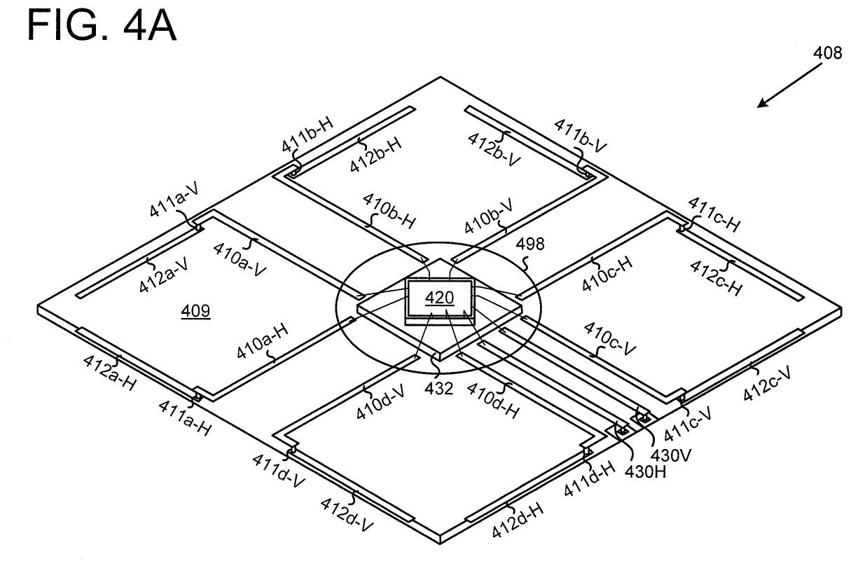

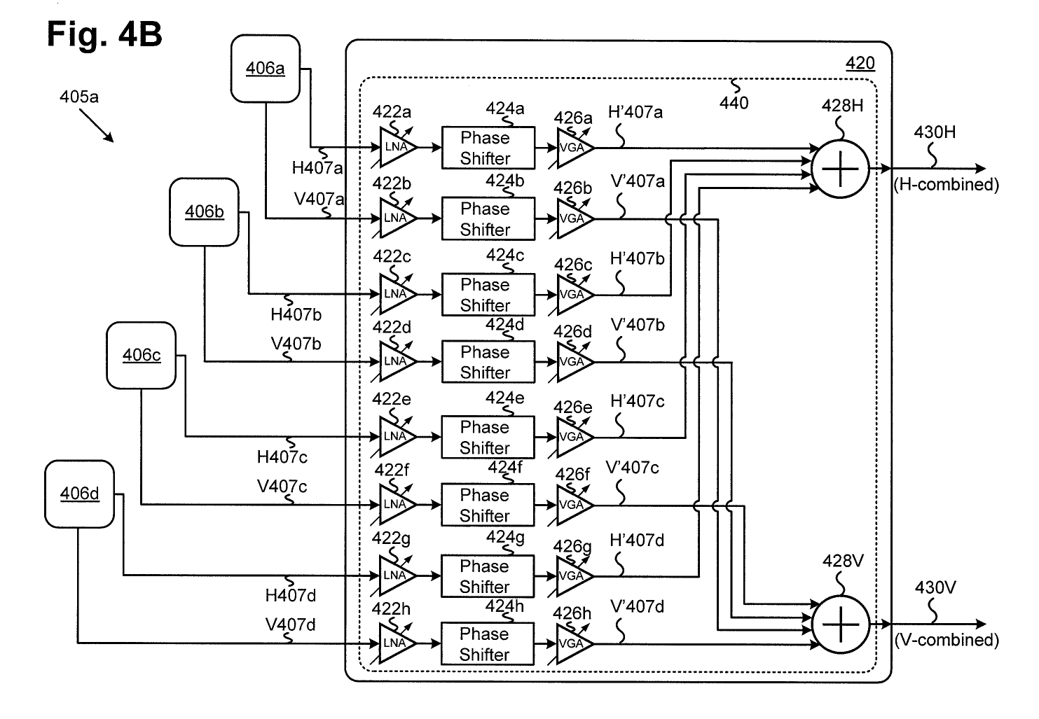

In the present implementation, each of semiconductor packages 108 includes a semiconductor die (not explicitly shown in FIG. 1A) situated on a low-loss substrate, such as a Rogers® board, i.e. a substrate made from Rogers® material, such as RO4000® laminates or RO4350B® laminates made by Rogers Corporation. At least one semiconductor die is situated in the center of semiconductor package 108a and covered by molding 198a. Similarly, a semiconductor die is situated in the center of semiconductor package 108n and covered by molding 198n. In the present implementation, each of semiconductor packages 108 includes four pairs of antenna probes (not explicitly shown in FIG. 1A), where each pair of antenna probes extends over a corresponding one of the neighboring cavities. In each of semiconductor packages 108, the four pairs of antenna probes are electrically coupled to a radio frequency (RF) front end circuit (not explicitly shown in FIG. 1A) integrated in the semiconductor die in the center of the semiconductor package. The RF front end circuit is configured to receive RF signals from the group of neighboring cavities through the corresponding pairs of antenna probes, amplify the RF signals, reduce signal noise, adjust the phase of the RF signals, and combine the RF signals, for example. Details of the semiconductor packages 108 are discussed with reference to FIGS. 4A and 4B.

Referring to FIG. 1B, FIG. 1B illustrates a perspective view of a portion of a phased array antenna panel according to one implementation of the present application. As illustrated in FIG. 1B, phased array antenna panel 100B includes metallic base 102, substrate 104, a plurality of cavities such as cavities 106a, 106b, 106c, 106d, 106w, 106x, 106y and 106z (hereinafter collectively referred to as cavities 106), a plurality of semiconductor packages such as semiconductor packages 108a and 108n (hereinafter collectively referred to as semiconductor packages 108), and a plurality of moldings such as moldings 198a and 198n (hereinafter collectively referred to as moldings 198). In the present implantation, metallic base 102, substrate 104, semiconductor packages 108 and moldings 198 in FIG. 1B may respectively correspond to metallic base 102, substrate 104, semiconductor packages 108 and moldings 198 of phased array antenna panel 100A in FIG. 1A. In contrast to cavities 106 in FIG. 1A each having a rectangular cuboid shape with a substantially square opening on top side 103 of phased array antenna panel 100A, as shown in FIG. 1B, each of cavities 106 is in a cylindrical shape with a substantially circular opening on top side 103 of phased array antenna panel 100B.

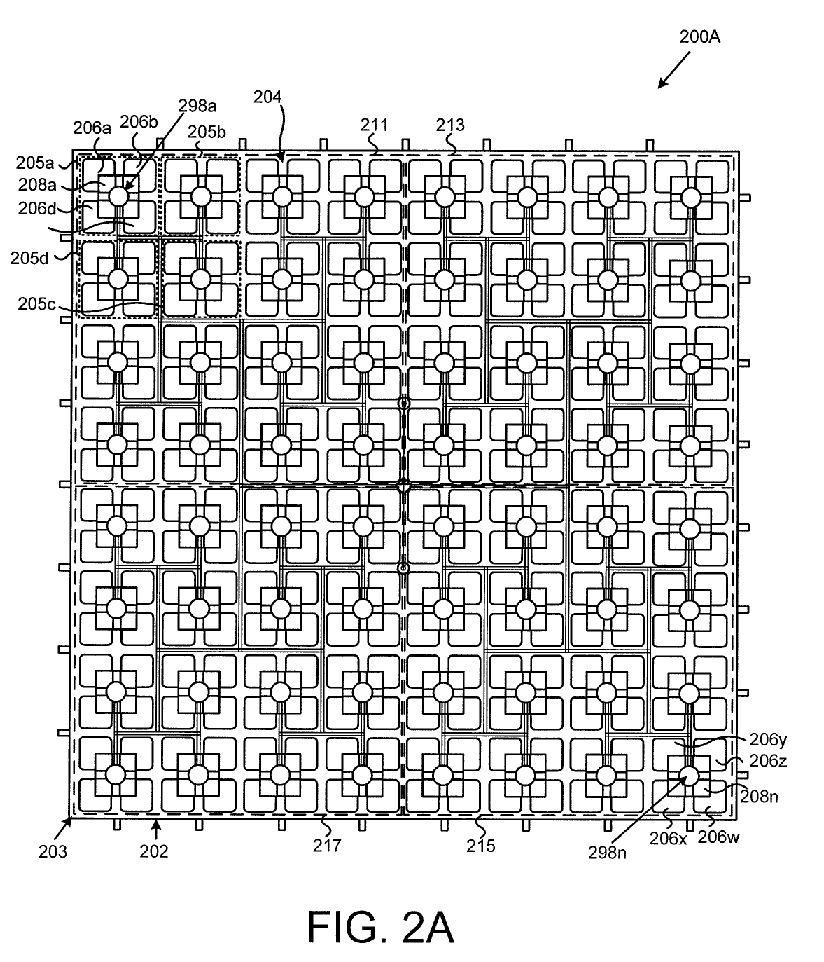

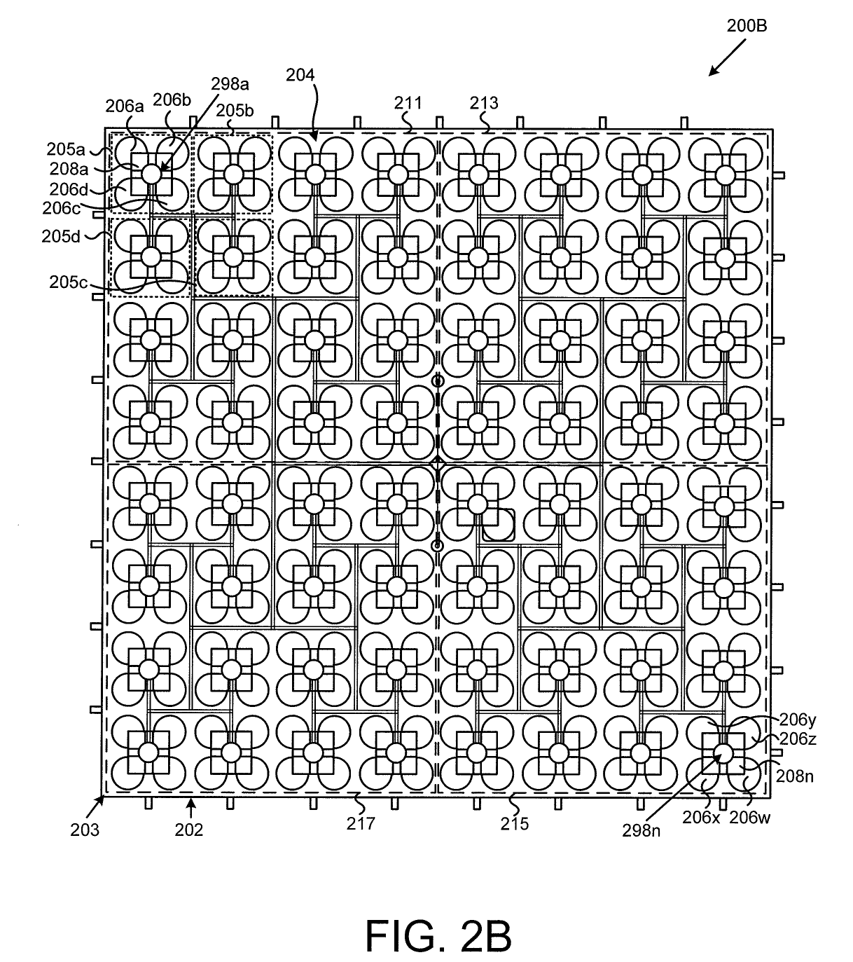

Referring to FIG. 2A, FIG. 2A illustrates a top plan view of a portion of a phased array antenna panel according to one implementation of the present application. In the present implementation, phased array antenna panel 200A illustrates a simplified layout of a phased array antenna panel, for example, as a part of a wireless receiver. As illustrated in FIG. 2A, phased array antenna panel 200A includes metallic base 202, substrate 204, a plurality of cavities such as cavities 206a, 206b, 206c, 206d, 206w, 206x, 206y and 206z (hereinafter collectively referred to as cavities 206), a plurality of semiconductor packages such as semiconductor packages 208a and 208n (hereinafter collectively referred to as semiconductor packages 208), and a plurality of moldings such as moldings 298a and 298n (hereinafter collectively referred to as moldings 298). In the present implantation, metallic base 202, substrate 204, semiconductor packages 208 and moldings 298 in FIG. 2A may respectively correspond to metallic base 102, substrate 104, semiconductor packages 108 and moldings 198 of phased array antenna panel 100A in FIG. 1A.

As illustrated in FIG. 2A, phased array antenna panel 200A includes segments 211, 213, 215 and 217. Each of segments 211, 213, 215 and 217 can be further divided into four sections, where each section includes four front end units, such as front end units 205a, 205b, 205c and 205d in one of the sections in segment 211. As shown in FIG. 2A, front end unit 205a includes semiconductor package 208a partially covering each of cavities 206a, 206b, 206c and 206d. Semiconductor package 208a includes four pairs of antenna probes (not explicitly shown in FIG. 2A), where each of the four pairs of antenna probes extends over a corresponding one of cavities 206a, 206b, 206c and 206d. As shown in FIG. 2A, the routing paths for front end units 205a, 205b, 205c and 205d are arranged in an H-configuration, where signals from each front end unit are routed through conductive traces on substrate 204. The routing paths for the four sections of front end units in segment 211 are also arranged in an H-configuration, where signals from each of the four sections in segment 211 are routed through conductive traces on substrate 204. As further shown in FIG. 2A, the routing paths for segments 211, 213, 215 and 217 are also arranged in an H-configuration. It is noted that, by adopting the present layout, the routing paths of RF signals received from cavities 206 are symmetric and substantially equal in length, thereby effectively reducing signal delays and increasing routing efficiency.

As illustrated in FIG. 2A, semiconductor packages 208 are situated over substrate 204, where each of semiconductor packages 208 partially extends over a group of four cavities. The formation of cavities 206 through substrate 204 into metallic base 202 creates ridges on top side 203 of phased array antenna panel 200A, where the ridges form a grid pattern. Semiconductor packages 208 are situated on and supported by the intersections of the ridges, while portions of each of semiconductor packages 208 partially extend over a group of neighboring cavities. For example, semiconductor package 208a partially extends over each of cavities 206a, 206b, 206c and 206d, while semiconductor package 208n partially extends over each of cavities 206w, 206x, 206y and 206z.

In the present implementation, metallic base 202 includes aluminum or aluminum alloy. In another implementation, metallic base 202 may include copper or other suitable metallic material. In the present implementation, substrate 204 is a low-cost substrate, such as a printed circuit/wiring board with conductive traces formed therein. In one implementation, substrate 204 may include FR-4 material, which is low cost and can deliver robust performance and durability. In one implementation, substrate 204 may include conductive traces that carry signals from each of semiconductor packages 208 to a master chip (not explicitly shown in FIG. 2A), for example. In the present implementation, each of cavities 206 has a rectangular cuboid shape with a substantially square opening on top side 203 of phased array antenna panel 200A. In the present implementation, cavities 206 are air cavities, as air has a low dielectric constant and is an excellent dielectric material for radio frequency antenna applications. In another implementation, cavities 206 may be filled with other suitable dielectric material with a low dielectric constant.

In the present implementation, each of semiconductor packages 208 includes a semiconductor die (not explicitly shown in FIG. 2A) situated on a low-loss substrate, such as a Rogers® board, i.e. a substrate made from Rogers® material, such as RO4000® laminates or RO4350® laminates made by Rogers Corporation. At least one semiconductor die is situated in the center of semiconductor package 208a and covered by molding 298a. Similarly, a semiconductor die is situated in the center of semiconductor package 208n and covered by molding 298n. In the present implementation, each of semiconductor packages 208 includes four pairs of antenna probes (not explicitly shown in FIG. 2A), where each pair of antenna probes extends over a corresponding one of the neighboring cavities.

In each of semiconductor packages 208, the four pairs of antenna probes are electrically coupled to a radio frequency (RF) front end circuit (not explicitly shown in FIG. 2A) integrated in the semiconductor die in the center of the semiconductor package. The RF front end circuit is configured to receive RF signals from the group of neighboring cavities through the corresponding pairs of antenna probes, amplify the RF signals, reduce signal noise, adjust the phase of the RF signals, and combine the RF signals, for example. The semiconductor package, such as semiconductor packages 208a and 208n, are discussed in more detail with reference to FIGS. 4A and 4B.

Referring to FIG. 2B, FIG. 2B illustrates a top plan view of a portion of a phased array antenna panel according to one implementation of the present application. As illustrated in FIG. 2B, phased array antenna panel 200B includes metallic base 202, substrate 204, a plurality of cavities such as cavities 206a, 206b, 206c, 206d, 206w, 206x, 206y and 206z (hereinafter collectively referred to as cavities 206), a plurality of semiconductor packages such as semiconductor packages 208a and 208n (hereinafter collectively referred to as semiconductor packages 208), and a plurality of moldings such as moldings 298a and 298n (hereinafter collectively referred to as moldings 298). As illustrated in FIG. 2B, phased array antenna panel 200B includes segments 211, 213, 215 and 217. Each of segments 211, 213, 215 and 217 can be further divided into four sections, where each section includes four front end units, such as front end units 205a, 205b, 205c and 205d in one of the sections in segment 211. In the present implantation, metallic base 202, substrate 204, semiconductor packages 208 and moldings 298 in FIG. 2B may respectively correspond to metallic base 202, substrate 204, semiconductor packages 208 and moldings 298 of phased array antenna panel 200A in FIG. 2A. In contrast to cavities 206 in FIG. 2A each having a rectangular cuboid shape with a substantially square opening on top side 203 of phased array antenna panel 200A, as shown in FIG. 2B, each of cavities 206 is in a cylindrical shape with a substantially circular opening on top side 203 of phased array antenna panel 200B.

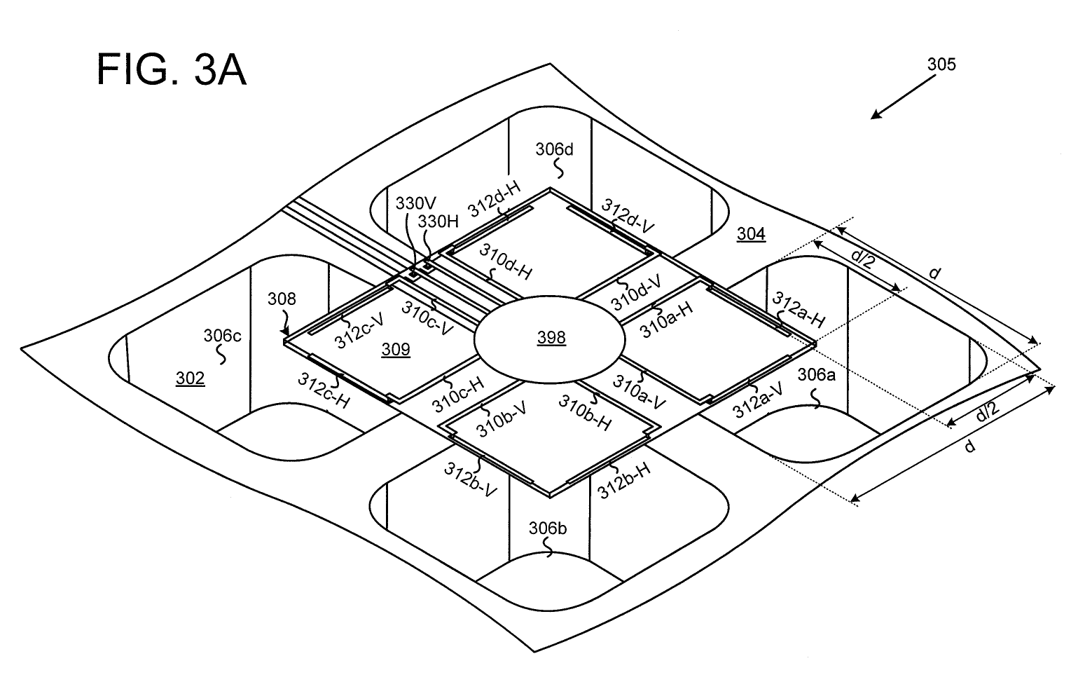

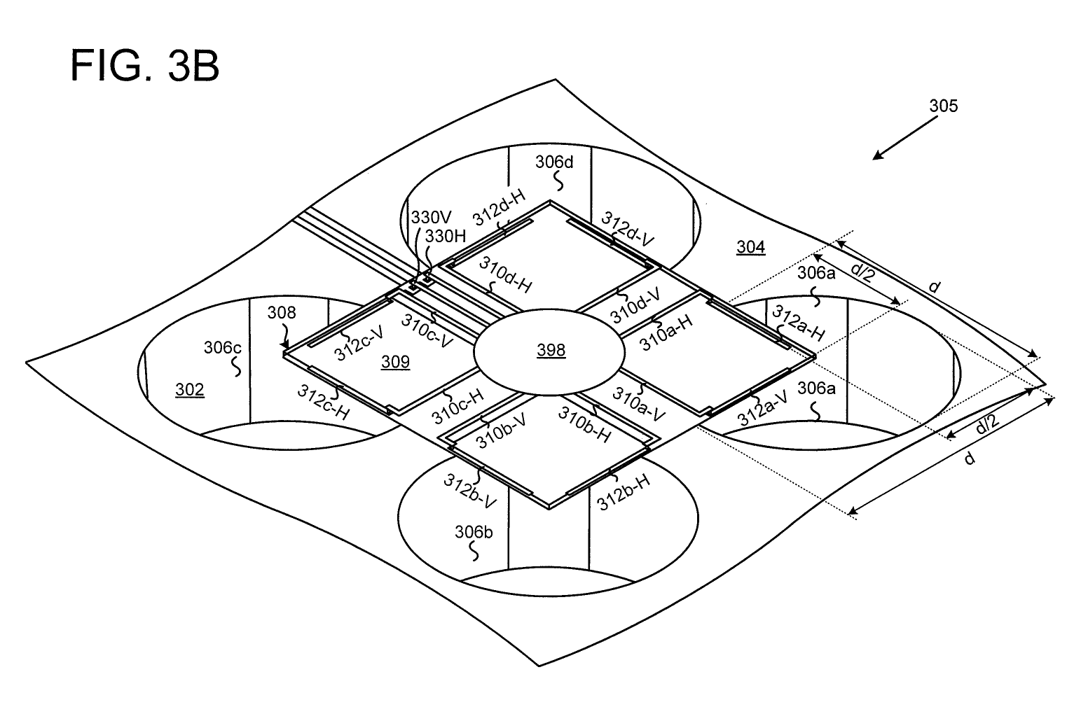

Referring to FIG. 3A, FIG. 3A illustrates a perspective view of a portion of a phased array antenna panel according to one implementation of the present application. In the present implementation, FIG. 3A shows front end unit 305 of a phased array antenna panel, where front end unit 305 may correspond to front end unit 205a in phased array antenna panel 200A in FIG. 2A. In the present implementation, metallic base 302, substrate 304, cavities 306a, 306b 306c and 306d, and semiconductor package 308 may respectively correspond to metallic base 102, substrate 104, cavities 106a, 106b, 106c and 106d, and semiconductor package 108a in FIG. 1A, or metallic base 202, substrate 204, cavities 206a, 206b, 206c and 206d, and semiconductor package 208a in FIG. 2A.

As illustrated in FIG. 3A, front end unit 305 includes cavities 306a, 306b 306c and 306d extending through substrate 304 into metallic base 302, and semiconductor package 308 situated on substrate 304 and partially covering each of cavities 306a, 306b 306c and 306d. Semiconductor package 308 includes low-loss substrate 309 and a semiconductor die (not explicitly shown in FIG. 3A) under molding 398. Semiconductor package 308 also includes four pairs of antenna probes, each of which extends over a corresponding one of the four neighboring cavities. For example, horizontal-polarization antenna probe (H-probe) 312a-H and vertical-polarization antenna probe (V-probe) 312a-V extend over cavity 306a. As illustrated in FIG. 3A, H-probe 312a-H is positioned at approximately the midpoint of one side of the substantially square opening of cavity 306a, and pointing toward the center of the substantially square opening of cavity 306a. Similarly, V-probe 312a-V is positioned at approximately the midpoint of an adjacent side of the substantially square opening of cavity 306a, and pointing toward the center of the substantially square opening of cavity 306a. H-probe 312a-H is substantially perpendicular to V-probe 312a-V. H-probe 312a-H is coupled to the semiconductor die under molding 398 through electrical connector 310a-H, while V-probe 312a-V is coupled to the semiconductor die under molding 398 through electrical connector 310a-V.

Similarly, horizontal-polarization antenna probe (H-probe) 312b-H and vertical-polarization antenna probe (V-probe) 312b-V extend over cavity 306b, and are substantially perpendicular to each other. H-probe 312b-H is coupled to the semiconductor die under molding 398 through electrical connector 310b-H, while V-probe 312b-V is coupled to the semiconductor die under molding 398 through electrical connector 310b-V. Horizontal-polarization antenna probe (H-probe) 312c-H and vertical-polarization antenna probe (V-probe) 312c-V extend over cavity 306c, and are substantially perpendicular to each other. H-probe 312c-H is coupled to the semiconductor die under molding 398 through electrical connector 310c-H, while V-probe 312c-V is coupled to the semiconductor die under molding 398 through electrical connector 310c-V. Horizontal-polarization antenna probe (H-probe) 312d-H and vertical-polarization antenna probe (V-probe) 312d-V extend over cavity 306d, and are substantially perpendicular to each other. H-probe 312d-H is coupled to the semiconductor die under molding 398 through electrical connector 310d-H, while V-probe 312d-V is coupled to the semiconductor die under molding 398 through electrical connector 310d-V. In the present implementation, electrical connectors 310a-H, 310a-V, 310b-H, 310b-V, 310c-H, 310c-V, 310d-H, and 310d-V are situated on a top side of low-loss substrate 309, and connected to antenna probes 312a-H, 312a-V, 312b-H, 312b-V, 312c-H, 312c-V, 312d-H, and 312d-V, respectively, on a bottom side of low-loss substrate 309, through conductive vias.

It is noted that the semiconductor die under molding 398 includes a radio frequency (RF) front end circuit integrated therein, where the RF front end circuit is configured to receive RF signals from the four pairs of antenna probes and provide a horizontally-polarized combined signal and a vertically-polarized combined signal through electrical connectors 330H and 330V, respectively, to a master chip (not explicitly shown in FIG. 3A) for further signal processing, for example.

Referring to FIG. 3B, FIG. 3B illustrates a perspective view of a portion of a phased array antenna panel according to one implementation of the present application. In the present implementation, FIG. 3B shows front end unit 305 of a phased array antenna panel, where front end unit 305 may correspond to front end unit 205a in phased array antenna panel 200B in FIG. 2B. In the present implementation, metallic base 302, substrate 304, cavities 306a, 306b 306c and 306d, and semiconductor package 308 may respectively correspond to metallic base 102, substrate 104, cavities 106a, 106b, 106c and 106d, and semiconductor package 108a in FIG. 1B, or metallic base 202, substrate 204, cavities 206a, 206b, 206c and 206d, and semiconductor package 208a in FIG. 2B.

As illustrated in FIG. 3B, front end unit 305 includes cavities 306a, 306b 306c and 306d extending through substrate 304 into metallic base 302, and semiconductor package 308 situated on substrate 304 and partially covering each of cavities 306a, 306b 306c and 306d. Semiconductor package 308 includes low-loss substrate 309 and a semiconductor die (not explicitly shown in FIG. 3B) under molding 398. Semiconductor package 308 also includes four pairs of antenna probes, each of which extends over a corresponding one of the four neighboring cavities.

In the present implementation, H-probes 312a-H, 312b-H, 312c-H and 312d-H, and V-probes 312a-V, 312b-V, 312c-V and 312d-V may correspond to H-probes 312a-H, 312b-H, 312c-H and 312d-H, and V-probes 312a-V, 312b-V, 312c-V and 312d-V, respectively, in FIG. 3A. Electrical connectors 310a-H, 310a-V, 310b-H, 310b-V, 310c-H, 310c-V, 310d-H, and 310d-V may correspond to electrical connectors 310a-H, 310a-V, 310b-H, 310b-V, 310c-H, 310c-V, 310d-H, and 310d-V, respectively, in FIG. 3A. In contrast to cavities 306a, 306b, 306c and 306d in FIG. 3A each having a rectangular cuboid shape with a substantially square opening, as shown in FIG. 3B, each of cavities 306a, 306b, 306c and 306d is in a cylindrical shape with a substantially circular opening.

Referring to FIG. 4A, FIG. 4A illustrates a perspective view of a semiconductor package of a phased array antenna panel according to one implementation of the present application. In the present implementation, semiconductor package 408 may correspond to any of semiconductor packages 108 in FIGS. 1A and 1B, semiconductor packages 208 in FIGS. 2A and 2B, and semiconductor packages 308 in FIGS. 3A and 3B. As shown in FIG. 4A, semiconductor package 408 includes low-loss substrate 409, and semiconductor die 420 situated on leadframe segment 432 and covered by molding 498. Semiconductor package 408 also includes four pairs of antenna probes coupled to semiconductor die 420 through corresponding electrical connectors, conductive vias and bond wires.

As illustrated in FIG. 4A, horizontal-polarization antenna probe (H-probe) 412a-H is situated on a bottom side of low-loss substrate 409, and connected to electrical connector 410a-H situated on a top side of low-loss substrate 409 through conductive via 411a-H. Vertical-polarization antenna probe (V-probe) 412a-V is situated on the bottom side of low-loss substrate 409, and connected to electrical connector 410a-V situated on the top side of low-loss substrate 409 through conductive via 411a-V. Similarly, horizontal-polarization antenna probe (H-probe) 412b-H is situated on the bottom side of low-loss substrate 409, and connected to electrical connector 410b-H situated on the top side of low-loss substrate 409 through conductive via 411b-H. Vertical-polarization antenna probe (V-probe) 412b-V is situated on the bottom side of low-loss substrate 409, and connected to electrical connector 410b-V situated on the top side of low-loss substrate 409 through conductive via 411b-V. Horizontal-polarization antenna probe (H-probe) 412c-H is situated on the bottom side of low-loss substrate 409, and connected to electrical connector 410c-H situated on the top side of low-loss substrate 409 through conductive via 411c-H. Vertical-polarization antenna probe (V-probe) 412c-V is situated on the bottom side of low-loss substrate 409, and connected to electrical connector 410c-V situated on the top side of low-loss substrate 409 through conductive via 411c-V. Horizontal-polarization antenna probe (H-probe) 412d-H is situated on the bottom side of low-loss substrate 409, and connected to electrical connector 410d-H situated on the top side of low-loss substrate 409 through conductive via 411d-H. Vertical-polarization antenna probe (V-probe) 412d-V is situated on the bottom side of low-loss substrate 409, and connected to electrical connector 410d-V situated on the top side of low-loss substrate 409 through conductive via 411d-V.

As shown in FIG. 4A, electrical connectors 410a-H, 410b-H, 410c-H, 410d-H, 410a-V, 410b-V, 410c-V and 410d-V are each electrically coupled to semiconductor die 420 through one or more bond wires. It should be noted that in another implementation, H-probes 412a-H, 412b-H, 412c-H and 412d-H, V-probes 412a-V, 412b-V, 412c-V and 412d-V, and electrical connectors 410a-H, 410b-H, 410c-H, 410d-H, 410a-V, 410b-V, 410c-V and 410d-V may be formed on the top or bottom side of low-loss substrate 409.

In the present implementation, H-probes 412a-H, 412b-H, 412c-H and 412d-H and V-probes 412a-V, 412b-V, 412c-V and 412d-V have substantially the same length. Also, electrical connectors 410a-H, 410b-H, 410c-H, 410d-H, 410a-V, 410b-V, 410c-V and 410d-V have substantially the same length. Thus, the routing paths for RF signals received through each of the antenna probes in semiconductor package 408 are substantially the same, thereby effectively reducing signal delays and increasing routing efficiency.

It is noted that semiconductor die 420 includes a radio frequency (RF) front end circuit integrated therein, where the RF front end circuit is configured to RF receive signals from the four pairs of antenna probes and provide a horizontally-polarized combined signal and a vertically-polarized combined signal through electrical connectors 430H and 430V, respectively, to a master chip (not explicitly shown in FIG. 4A) for further signal processing, for example.

Referring now to FIG. 4B, FIG. 4B illustrates a functional block diagram of a radio frequency front end circuit of a semiconductor package according to one implementation of the present application. As illustrated in FIG. 4B, front end unit 405a includes cavities 406a, 406b, 406c and 406d coupled to radio frequency (RF) front end circuit 440 in semiconductor die 420. In the present implementation, cavities 406a, 406b, 406c and 406d may respectively correspond to cavities 106a, 106b, 106c and 106d in FIGS. 1A and 1B, cavities 206a, 206b, 206c and 206d in FIGS. 2A and 2B, and cavities 306a, 306b, 306c and 306d in FIGS. 3A and 3B. In the present implementation, semiconductor die 420 may correspond to semiconductor die 420 in FIG. 4A.

In the present implementation, cavities 406a, 406b, 406c and 406d may be configured to receive RF signals from one or more commercial geostationary communication satellites, for example, which typically employ linearly polarized signals defined at the satellite with a horizontally-polarized (H) signal having its electric-field oriented parallel with the equatorial plane and a vertically-polarized (V) signal having its electric-field oriented perpendicular to the equatorial plane. As illustrated in FIG. 4B, each of cavities 406a, 406b, 406c and 406d is configured to provide an H output and a V output to semiconductor die 420. For example, cavity 406a provides horizontally-polarized signal H407a and vertically-polarized signal V407a to RF front end circuit 440. Cavity 406b provides horizontally-polarized signal H407b and vertically-polarized signal V407b to RF front end circuit 440. Cavity 406c provides horizontally-polarized signal H407c and vertically-polarized signal V407c to RF front end circuit 440. Cavity 406d provides horizontally-polarized signal H407d and vertically-polarized signal V407d to RF front end circuit 440. It is noted that H-probes 412a-H, 412b-H, 412c-H and 412d-H, V-probes 412a-V, 412b-V, 412c-V and 412d-V, electrical connectors 410a-H, 410b-H, 410c-H, 410d-H, 410a-V, 410b-V, 410c-V, and conductive vias 411a-H, 411b-H, 411c-H, 411d-H, 411a-V, 411b-V, 411c-V and 411d-V and the bond wires in semiconductor package 408 as shown in FIG. 4A are omitted from FIG. 4B for conceptual clarity. It should be understood that the RF signals received from cavities 406a, 406b, 406c and 406d are provided to RF front end circuit 440 in semiconductor die 420 through these above-mentioned features.

As illustrated in FIG. 4B, horizontally-polarized signal H407a from cavity 406a is provided to a receiving circuit having low noise amplifier (LNA) 422a, phase shifter 424a and variable gain amplifier (VGA) 426a, where LNA 422a is configured to generate an output to phase shifter 424a, and phase shifter 424a is configured to generate an output to VGA 426a. In addition, vertically-polarized signal V407a from cavity 406a is provided to a receiving circuit including low noise amplifier (LNA) 422b, phase shifter 424b and variable gain amplifier (VGA) 426b, where LNA 422b is configured to generate an output to phase shifter 424b, and phase shifter 424b is configured to generate an output to VGA 426b. Horizontally-polarized signal H407b from cavity 406b is provided to a receiving circuit having low noise amplifier (LNA) 422c, phase shifter 424c and variable gain amplifier (VGA) 426c, where LNA 422c is configured to generate an output to phase shifter 424c, and phase shifter 424c is configured to generate an output to VGA 426c. In addition, vertically-polarized signal V407b from cavity 406b is provided to a receiving circuit including low noise amplifier (LNA) 422d, phase shifter 424d and variable gain amplifier (VGA) 426d, where LNA 422d is configured to generate an output to phase shifter 424d, and phase shifter 424d is configured to generate an output to VGA 426d.

As further illustrated in FIG. 4B, horizontally-polarized signal H407c from cavity 406c is provided to a receiving circuit having low noise amplifier (LNA) 422e, phase shifter 424e and variable gain amplifier (VGA) 426e, where LNA 422e is configured to generate an output to phase shifter 424e, and phase shifter 424e is configured to generate an output to VGA 426e. In addition, vertically-polarized signal V407c from cavity 406c is provided to a receiving circuit including low noise amplifier (LNA) 422f, phase shifter 424f and variable gain amplifier (VGA) 426f, where LNA 422f is configured to generate an output to phase shifter 424f, and phase shifter 424f is configured to generate an output to VGA 426f. Horizontally-polarized signal H407d from cavity 406d is provided to a receiving circuit having low noise amplifier (LNA) 422g, phase shifter 424g and variable gain amplifier (VGA) 426g, where LNA 422g is configured to generate an output to phase shifter 424g, and phase shifter 424g is configured to generate an output to VGA 426g. In addition, vertically-polarized signal V407d from cavity 406d is provided to a receiving circuit including low noise amplifier (LNA) 422h, phase shifter 424h and variable gain amplifier (VGA) 426h, where LNA 422h is configured to generate an output to phase shifter 424h, and phase shifter 424h is configured to generate an output to VGA 426h.

As illustrated in FIG. 4B, amplified and phase shifted horizontally-polarized signals H′407a from cavity 406a, H′407b from cavity 406b, H′407c from cavity 406c and H′407d from cavity 406d, are provided to summation block 428H, that is configured sum all of the powers of the amplified and phase shifted horizontally-polarized signals, and combine all of the phases of the amplified and phase shifted horizontally-polarized signals, to provide horizontally-polarized combined signal 430H, for example, to a master chip (not explicitly shown in FIG. 4B). Similarly, amplified and phase shifted vertically-polarized signals V′407a from cavity 406a, V′407b from cavity 406b, V′407c from cavity 406c and V′407d from cavity 406d, are provided to summation block 428V, that is configured sum all of the powers of the amplified and phase shifted vertically-polarized signals, and combine all of the phases of the amplified and phase shifted vertically-polarized signals, to provide vertically-polarized combined signal 430V, for example, to the master chip (not explicitly shown in FIG. 4B).

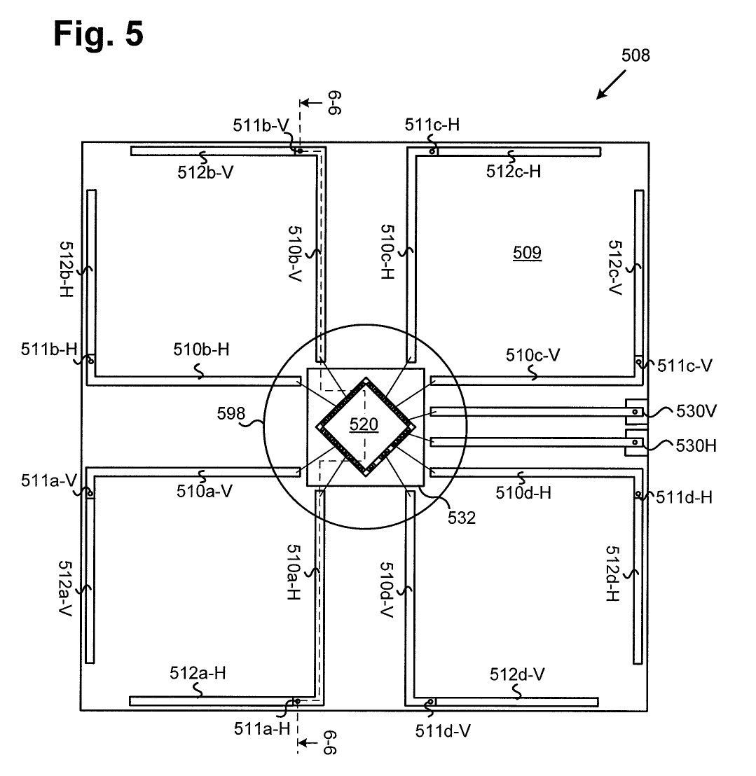

Referring to FIG. 5, FIG. 5 illustrates a top plan view of a semiconductor package of a phased array antenna panel according to one implementation of the present application. In the present implementation, semiconductor package 508 may correspond to any of semiconductor packages 108 in FIGS. 1A and 1B, semiconductor packages 208 in FIGS. 2A and 2B, semiconductor packages 308 in FIGS. 3A and 3B, and semiconductor package 408 in FIG. 4A. As shown in FIG. 5, semiconductor package 508 includes low-loss substrate 509, and semiconductor die 520 situated on leadframe segment 532 and covered by molding 598. Semiconductor package 508 also includes four pairs of antenna probes coupled to semiconductor die 520 through corresponding electrical connectors, conductive vias and bond wires.

As shown in FIG. 5, semiconductor die 520 and electrical connectors 510a-H, 510b-H, 510c-H, 510d-H, 510a-V, 510b-V, 510c-V and 510d-V are situated on a top side of low-loss substrate 509, where each of the electrical connectors is electrically coupled to semiconductor die 520 through one or more bond wires. As illustrated in FIG. 5, horizontal-polarization antenna probe (H-probe) 512a-H is situated on a bottom side of low-loss substrate 509, and connected to electrical connector 510a-H situated on the top side of low-loss substrate 509 through conductive via 511a-H. Vertical-polarization antenna probe (V-probe) 512a-V is situated on the bottom side of low-loss substrate 509, and connected to electrical connector 510a-V situated on the top side of low-loss substrate 509 through conductive via 511a-V. Similarly, horizontal-polarization antenna probe (H-probe) 512b-H is situated on the bottom side of low-loss substrate 509, and connected to electrical connector 510b-H situated on the top side of low-loss substrate 509 through conductive via 511b-H. Vertical-polarization antenna probe (V-probe) 512b-V is situated on the bottom side of low-loss substrate 509, and connected to electrical connector 510b-V situated on the top side of low-loss substrate 509 through conductive via 511b-V. Horizontal-polarization antenna probe (H-probe) 512c-H is situated on the bottom side of low-loss substrate 509, and connected to electrical connector 510c-H situated on the top side of low-loss substrate 509 through conductive via 511c-H. Vertical-polarization antenna probe (V-probe) 512c-V is situated on the bottom side of low-loss substrate 509, and connected to electrical connector 510c-V situated on the top side of low-loss substrate 509 through conductive via 511c-V. Horizontal-polarization antenna probe (H-probe) 512d-H is situated on the bottom side of low-loss substrate 509, and connected to electrical connector 510d-H situated on the top side of low-loss substrate 509 through conductive via 511d-H. Vertical-polarization antenna probe (V-probe) 512d-V is situated on the bottom side of low-loss substrate 509, and connected to electrical connector 510d-V situated on the top side of low-loss substrate 509 through conductive via 511d-V.

In the present implementation, H-probes 512a-H, 512b-H, 512c-H and 512d-H and V-probes 512a-V, 512b-V, 512c-V and 512d-V have substantially the same length. Also, electrical connectors 510a-H, 510b-H, 510c-H, 510d-H, 510a-V, 510b-V, 510c-V and 510d-V have substantially the same length. Thus, the routing paths for RF signals received through each of the antenna probes in semiconductor package 508 are substantially the same. It is also noted that, in the present implementation, semiconductor die 520 is situated on leadframe segment 532 in the center of semiconductor package 508. As illustrated in FIG. 5, leadframe segment 532 has a substantially square shape, where the four edges of leadframe segment 532 are substantially parallel with the four edges of low-loss substrate 509. By contrast, semiconductor die 520 is oriented at a 45-degree angle with respect to leadframe segment 532. As such, semiconductor die 520 is situated from each of electrical connectors 510a-H, 510b-H, 510c-H, 510d-H, 510a-V, 510b-V, 510c-V and 510d-V at substantially equal distances. Thus, RF signals from H-probes 512a-H, 512b-H, 512c-H and 512d-H and V-probes 512a-V, 512b-V, 512c-V and 512d-V travel substantially equal distances before reaching semiconductor die 520. The symmetry in the routing paths can effectively increase routing efficiency and reduce signal delays. It is noted that semiconductor die 520 includes a radio frequency (RF) front end circuit integrated therein, where the RF front end circuit is configured to RF receive signals from the four pairs of antenna probes and provide a horizontally-polarized combined signal and a vertically-polarized combined signal through electrical connectors 530H and 530V, respectively, to a master chip (not explicitly shown in FIG. 5) for further signal processing, for example.

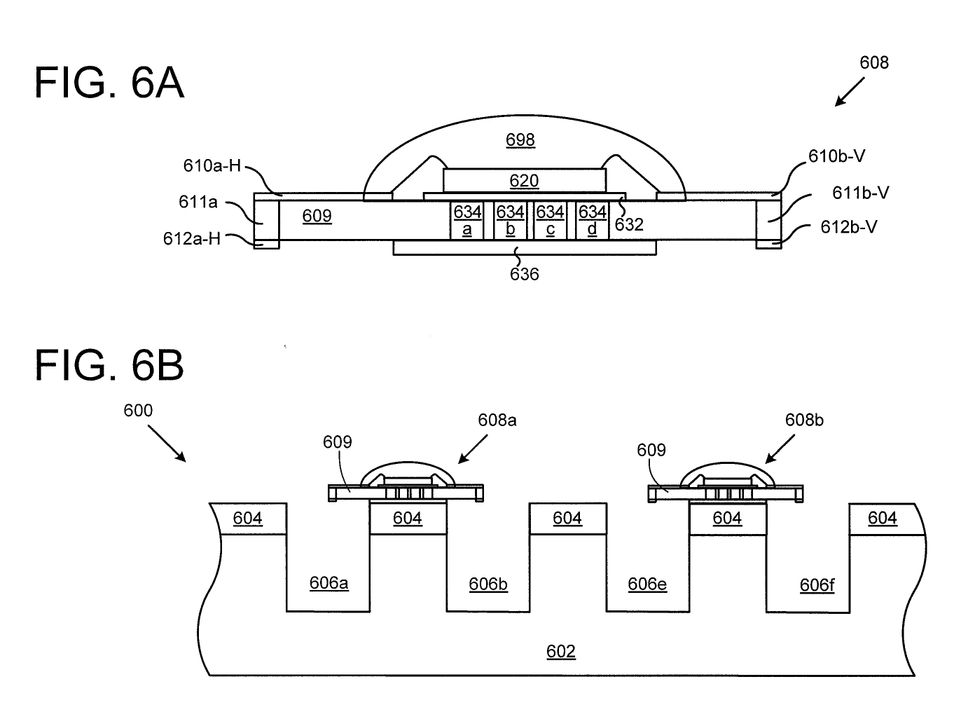

Referring to FIG. 6A, FIG. 6A illustrates a cross-sectional view of a semiconductor package of a phased array antenna panel according to one implementation of the present application. In the present implementation, FIG. 6A illustrates a cross-sectional view of semiconductor package 508 in FIG. 5 along line 6-6 in that Figure (i.e. in FIG. 5). As shown in FIG. 6A, semiconductor die 620 is situated on leadframe segment 632 over a top side of low-loss substrate 609. Electrical connectors 610a-H and 610b-V are also situated over the top side of low-loss substrate 609. Low-loss substrate 609 may include conductive vias 611a-H and 611b-V, and ground vias 634a, 634b, 634c and 634d. Electrical connector 610a-H is coupled to H-probe 612a-H through conductive via 611a-H, while electrical connector 610b-V is coupled to V-probe 612b-V through conductive via 611b-V. Electrical connectors 610a-H and 610b-V are each coupled to semiconductor die 620 through a bond wire. Semiconductor die 620 may be coupled to ground plate 636 on a bottom side of low-loss substrate 609 through ground vias 634a, 634b, 634c and 634d under leadframe segment 632. As can be seen in FIG. 6A, molding 698 encapsulates semiconductor die 620, leadframe segment 632, portions of electrical connectors 610a-H and 610b-V, and the bond wires connecting semiconductor die 620 to electrical connectors 610a-H and 610b-V. Molding 698 provides protection to the above-mentioned features to prevent erosion and undesirable movements.

Referring to FIG. 6B, FIG. 6B illustrates a cross-sectional view of a portion of a phased array antenna panel according to one implementation of the present application. As illustrated in FIG. 6B, phased array antenna panel 600 includes metallic base 602, substrate 604, cavities 606a, 606b, 606e and 606f, and semiconductor packages 608a and 608b. As illustrated in FIG. 6B, substrate 604 is situated over metallic base 602. Semiconductor packages 608a and 608b are situated over substrate 604. Cavities 606a, 606b, 606e and 606f extend through substrate 604 into metallic base 602. Semiconductor package 608a partially extends over cavities 606a and 606b, while semiconductor package 608b partially extends over cavities 606e and 606f.

In the present implementation, metallic base 602 includes aluminum or aluminum alloy. In another implementation, metallic base 602 may include copper or other suitable metallic material. In the present implementation, substrate 604 is a low cost substrate, such as a printed circuit/wiring board with conductive traces formed therein. In one implementation, substrate 604 may include FR-4 material, which is low cost and can deliver robust performance and durability. In one implementation, substrate 604 may include conductive traces that carry combined horizontally-polarized combined signals and combined vertically-polarized combined signals from each of semiconductor packages 608a and 608b to a master chip (not explicitly shown in FIG. 6B) for example. In the present implementation, each of cavities 606a, 606b, 606e and 606f has a rectangular cuboid shape. In the present implementation, cavities 606a, 606b, 606e and 606f are air cavities, as air has a low dielectric constant and is an excellent dielectric material for radio frequency antenna applications. In another implementation, cavities 606a, 606b, 606e and 606f may be filled with other suitable dielectric material with a low dielectric constant.

In the present implementation, semiconductor packages 608a and 608b may each correspond to semiconductor package 608 in FIG. 6A. Each of semiconductor packages 608a and 608b includes a semiconductor die (e.g., semiconductor die 620 in FIG. 6A) situated on a low-loss substrate (e.g., low-loss substrate 609 in FIG. 6A). In the present implementation, each of semiconductor packages 608a and 608b includes four pairs of antenna probes (not explicitly shown in FIG. 6B), where each pair of antenna probes extends over a corresponding cavity.

In one implementation, low-loss substrate 609 may include material that has low dielectric loss and low signal loss, such as a Rogers® board, i.e. a substrate made from Rogers® material, such as RO4000® laminates or RO4350B® laminates made by Rogers Corporation. Low-loss substrate 609 is compatible with substrate 604 in terms of the fabrication process and the coefficient of thermal expansion. In addition, low-loss substrate 609 has a high thermal conductivity that can effectively draw heat out of semiconductor die 620. Because semiconductor packages 608a and 608b each use a low-loss substrate 609, the energy loss between the antenna probes and the RF front end circuit can be effectively reduced. Moreover, the close proximity and the symmetric routing paths from the antenna probes to the RF front end circuit in low-loss substrate 609 further reduce the energy loss between the antenna probes and the RF front end circuit. Once the RF signals are amplified, phase shifted and combined by the RF front end circuit, the horizontally-polarized combined signal and the vertically-polarized combined signal are provided to a master chip using conductive traces on a low-cost substrate, such as substrate 604. As a result, the combination of low-loss substrate 609 (e.g., having Rogers® material) and low-cost substrate 604 (e.g., having FR-4 material) reduces the overcall cost of phased array antenna panel 600.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

1. A phased array antenna panel comprising:
a first substrate over a metallic base;
a cavity in said first substrate and said metallic base;
a semiconductor die situated over said first substrate;
wherein said semiconductor die is coupled to at least one antenna probe over said cavity.

2. The phased array antenna panel of claim 1 wherein said semiconductor die is situated in a semiconductor package formed in a second substrate.

3. The phased array antenna panel of claim 2 wherein said antenna probe is in said second substrate, said antenna probe situated over said cavity.

4. The phased array antenna panel of claim 1 wherein said cavity has a rectangular cuboid shape.

5. The phased array antenna panel of claim 1 wherein said cavity has a cylindrical shape.

6. The phased array antenna panel of claim 1 wherein said first substrate comprises FR-4 material.

7. The phased array antenna panel of claim 2 wherein said second substrate comprises Rogers® material.

8. The phased array antenna panel of claim 1 wherein said at least one antenna probe comprises a horizontal-polarization antenna probe.

9. The phased array antenna panel of claim 1 wherein said at least one antenna probe comprises a vertical-polarization antenna probe.

10. The phased array antenna panel of claim 1 wherein said cavity is an air cavity.

11. A phased array antenna panel comprising:
a first substrate over a metallic base;
a plurality of cavities in said first substrate and said metallic base;
a plurality of semiconductor dies situated over said first substrate, at least one of said plurality of semiconductor dies is situated in a semiconductor package formed in a second substrate;
wherein said at least one of said plurality of semiconductor dies is coupled to at least one pair of antenna probes over one of said plurality of cavities;
wherein said semiconductor die is further coupled to electrical connectors configured to carry combined horizontally-polarized signals and combined vertically-polarized signals.

12. The phased array antenna panel of claim 11 wherein said semiconductor package comprises four pairs of antenna probes.

13. The phased array antenna panel of claim 12 wherein each of said four pairs of antenna probes extends over a corresponding one of said plurality of cavities.

14. The phased array antenna panel of claim 11 wherein said semiconductor package partially covers four of said plurality of cavities.

15. The phased array antenna panel of claim 11 wherein each of said plurality of cavities has a rectangular cuboid shape.

16. The phased array antenna panel of claim 11 wherein each of said plurality of cavities has a cylindrical shape.

17. The phased array antenna panel of claim 11 wherein said first substrate comprises FR-4 material.

18. The phased array antenna panel of claim 11 wherein said second substrate comprises Rogers® material.

19. The phased array antenna panel of claim 11 wherein said at least one pair of antenna probes comprises a horizontal polarization antenna probe and a vertical polarization antenna probe.

20. The phased array antenna panel of claim 19 wherein said horizontal polarization antenna probe and said vertical polarization antenna probe are substantially perpendicular to each other.
